(19) United States
(12) Patent Application Publication
(10) Pub. No.: US 2026/0239056 A1
(43) Pub. Date: Aug. 13, 2026

(54) DYNAMIC CROSS-LINK INTERFERENCE MEASUREMENTS IN MULTIPLE MEASUREMENT OCCASIONS

(71) Applicant: QUALCOMM Incorporated, San Diego, CA (US)

(72) Inventors: Yuwei REN, Beijing (CN); Yan ZHOU, San Diego, CA (US); Huilin XU, Beijing (CN); Qian ZHANG, Basking Ridge, NJ (US)

(21) Appl. No.: 19/475,227

(22) PCT Filed: May 17, 2023
(86) PCT No.: PCT/CN2023/094703

§ 371 Date: Oct. 14, 2025

(51) Int. Cl. H04W 24/08; H04W 24/10; H04W 72/1268

(52) U.S. Cl. CPC H04W 24/08; H04W 24/10; H04W 72/1268

(57) ABSTRACT

Wireless communications systems, apparatuses, and methods are provided. A method of wireless communication performed by a first user equipment (UE) includes receiving, from a network unit, a cross link interference (CLI) measurement resource configuration, wherein the CLI measurement resource configuration indicates a plurality of CLI measurement occasions, measuring CLI associated with a second UE in the plurality of CLI measurement occasions, and transmitting, to the network unit, one or more CLI measurement reports associated with the measured CLI.

### TECHNICAL FIELD

This application relates to wireless communication systems, and more particularly, to dynamic cross-link interference measurements in multiple measurement occasions.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first user equipment (UE) may include receiving, from a network unit, a cross link interference (CLI) measurement resource configuration, wherein the CLI measurement resource configuration indicates a plurality of CLI measurement occasions; measuring CLI associated with a second UE in the plurality of CLI measurement occasions; and transmitting, to the network unit, one or more CLI measurement reports associated with the measured CLI.

In an additional aspect of the disclosure, a method of wireless communication performed by a network unit, may include transmitting, to a first user equipment (UE), a cross link interference (CLI) measurement resource configuration, wherein the CLI measurement resource configuration indicates a plurality of CLI measurement occasions; and receiving, from the first UE, one or more CLI measurement reports associated with the plurality of CLI measurement occasions, wherein the one or more measurement reports indicate CLI associated with a second UE.

In an additional aspect of the disclosure, a first user equipment (UE) may include a memory; a transceiver; and at least one processor coupled to the memory and the transceiver, wherein the first UE is configured to receive, from a network unit, a cross link interference (CLI) measurement resource configuration, wherein the CLI measurement resource configuration indicates a plurality of CLI measurement occasions; measure CLI associated with a second UE in the plurality of CLI measurement occasions; and transmit, to the network unit, one or more CLI measurement reports associated with the measured CLI.

In an additional aspect of the disclosure, a network unit may include a memory; a transceiver; and at least one processor coupled to the memory and the transceiver, wherein the network unit is configured to transmit, to a first user equipment (UE), a cross link interference (CLI) measurement resource configuration, wherein the CLI measurement resource configuration indicates a plurality of CLI measurement occasions; and receive, from the first UE, one or more CLI measurement reports associated with the plurality of CLI measurement occasions, wherein the one or more measurement reports indicate CLI associated with a second UE.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates a lookup table configuration for multiple CLI measurement occasions according to some aspects of the present disclosure.

FIG. 4 illustrates a configuration for multiple CLI measurement occasions according to some aspects of the present disclosure.

FIG. 5 illustrates a configuration for filtering multiple CLI measurements according to some aspects of the present disclosure.

FIG. 6 illustrates overlapping CLI measurement occasions according to some aspects of the present disclosure.

FIG. 7 is a signal flow diagram according to some aspects of the present disclosure.

FIG. 8 is a block diagram of an exemplary user equipment (UE) according to some aspects of the present disclosure.

FIG. 9 is a block diagram of an exemplary network unit according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1M nodes/km2), ultra-low complexity (e.g., ~10 s of bits/sec), ultra-low energy (e.g., ~10+years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km2 ), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (Rus)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

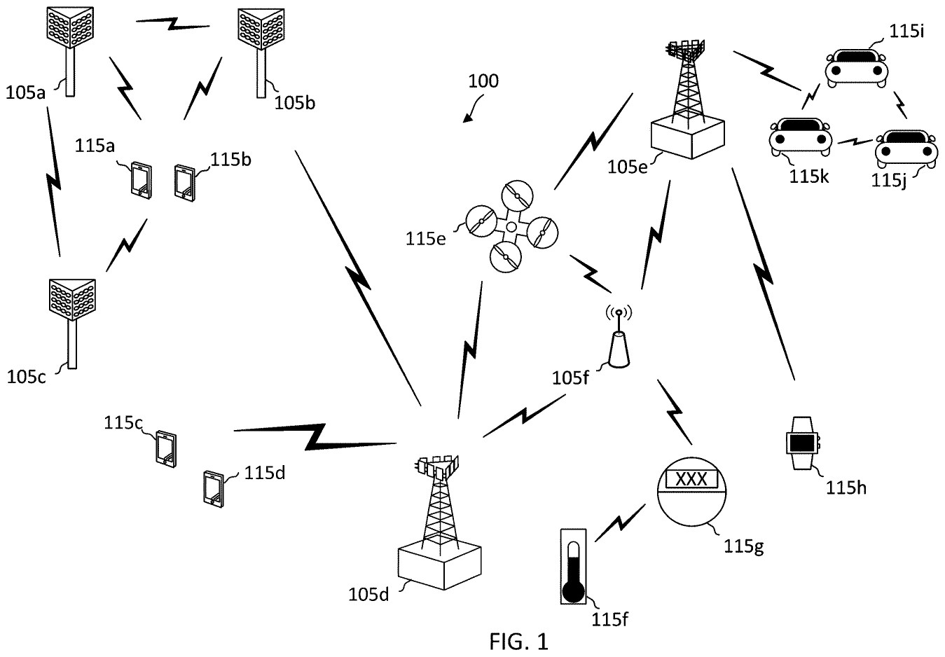

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105 a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115a may receive a cross link interference (CLI) measurement resource configuration from the BS 105. In some aspects, the CLI measurement resource configuration may indicate a plurality of CLI measurement occasions. The UE 115a may measure CLI associated with the UE 115b in the plurality of CLI measurement occasions and transmit one or more CLI measurement reports to the BS 105 associated with the measured CLI.

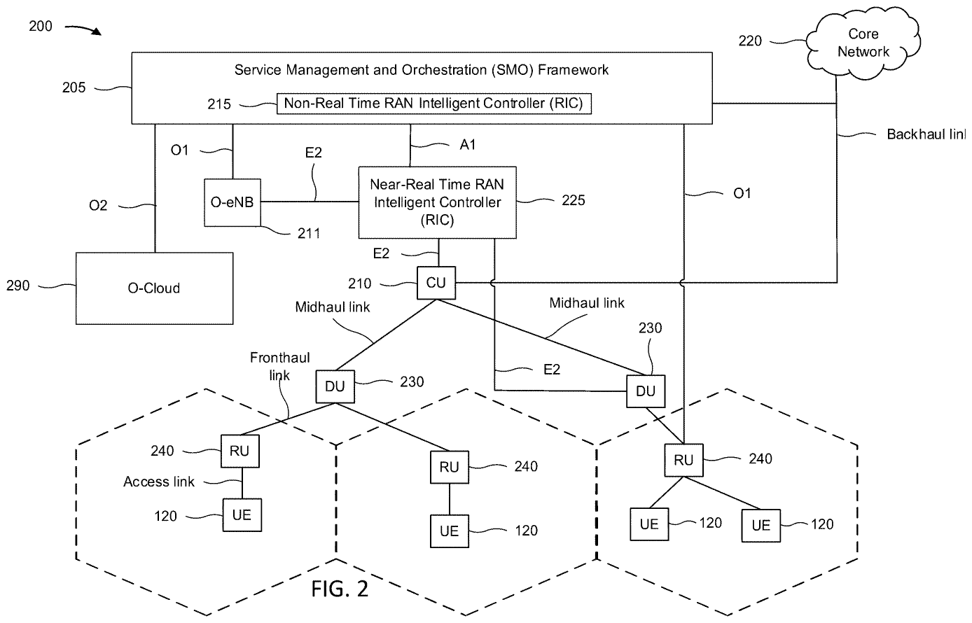

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an Ol interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, a first UE 115 may receive a cross link interference (CLI) measurement resource configuration from the RU 240, DU 230, and/or CU 210. In some aspects, the CLI measurement resource configuration may indicate a plurality of CLI measurement occasions. The first UE 115 may measure CLI associated with a second UE 115 in the plurality of CLI measurement occasions and transmit one or more CLI measurement reports associated with the measured CLI to the RU 240, DU 230, and/or CU 210.

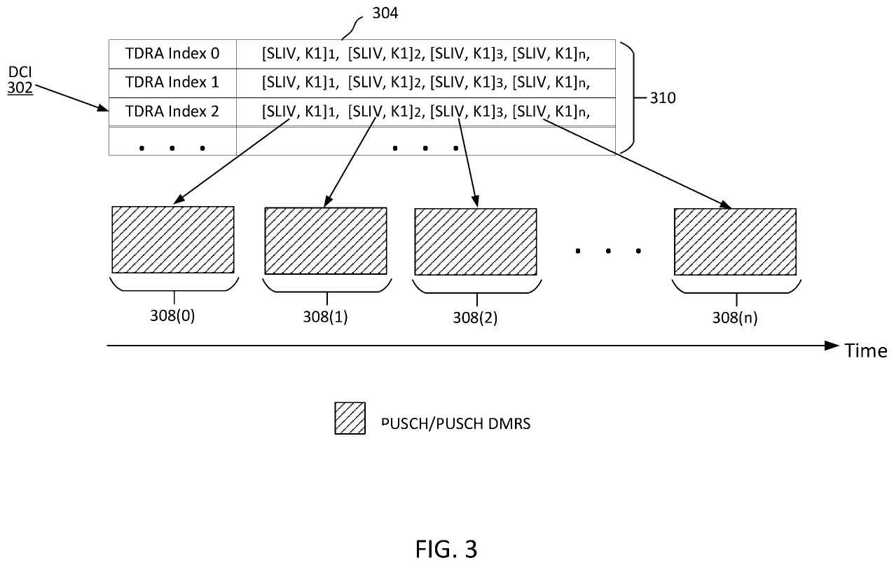

FIG. 3 illustrates a time domain resource allocation (TDRA) table 304 indicating multiple CLI measurement occasions 308 according to some aspects of the present disclosure. In some aspects, a first UE (e.g., the UE 115 or UE 800) may receive a cross link interference (CLI) measurement resource configuration from a network unit (e.g., the network unit 105 or 900). In this regard, the first UE may receive the CLI measurement resource configuration in the form of TDRA table 304 from the network unit via a radio resource control (RRC) communication, downlink control information (DCI), a MAC-CE communication, or other suitable communication. In some aspects, the TDRA table 304 may indicate a plurality of CLI measurement occasions 308 (e.g., CLI measurement occasions 308(0) to 308(n)). The first UE may experience (e.g., be a victim of) CLI from one or more other UEs nearby the first UE. The first UE may measure the CLI in the CLI measurement occasions 308 in order to report the CLI to the network unit and minimize interference effects from the other UEs.

In some aspects, CLI measurement resources may include the TDRA table 304 indicating resources associated with physical uplink shared channel (PUSCH) communications scheduled for the second UE. The first UE may measure the CLI from the PUSCH communications transmitted by the second UE. In this case, the first UE may receive the CLI measurement resource configuration via an index to an entry in the TDRA table (e.g., the first column of TDRA table 304). In this regard, the first UE may receive the index to the TDRA table 304 via DCI 302. In some aspects, the TDRA table 304 may include multiple rows 310. The index may point to one of the multiple rows 310 of CLI measurement occasions 308. Each row 310 may indicate a plurality of CLI measurement occasions 308. Each of the CLI measurements occasions 308 may include a starting symbol associated with the CLI measurement occasion, a number of symbols associated with the CLI measurement occasion (e.g., start and length indicator value (SLIV)) and/or a slot offset (e.g., K1) associated with the CLI measurement occasion 308.

In some aspects, the first UE may measure CLI associated with the second UE. In this regard, the first UE may measure the CLI caused by communications transmitted by the second UE in the plurality of CLI measurement occasions 308. In some aspects, the CLI measurements may include reference signal received power (RSRP) measurements of sounding reference signals (SRSs) transmitted by the second UE. In some aspects, the CLI measurements may include received signal strength indicator (RSSI) measurements associated with PUCCH communications, PUSCH communications, PUSCH DMRSs, and/or SRSs transmitted by the second UE. In some aspects, the CLI measurements may include signal to interference plus noise (SINR) measurements associated with PUCCH communications, PUSCH communications, PUSCH DMRSs, and/or SRSs transmitted by the second UE.

In some aspects, the first UE may measure the CLI in the plurality of CLI measurement occasions 308 based on receiving the CLI measurement resource configuration (e.g., the TDRA table 304). In this case, the first UE receiving the CLI measurement resource configuration from the network unit may implicitly trigger the first UE to measure the CLI in the configured CLI measurement occasions 308. Additionally or alternatively, the first UE may receive the CLI measurement resource configuration from the network unit and subsequently receive an indicator (e.g., via DCI 302, a MAC-CE communication, an RRC communication, a PDCCH communication, a PDSCH communication, and/or other suitable communication) to trigger the CLI measurements.

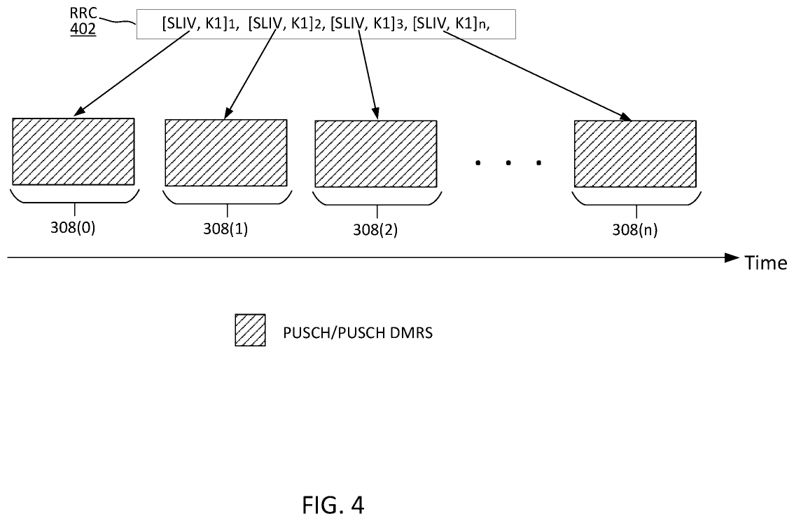

FIG. 4 illustrates a CLI measurement resource configuration indicating multiple CLI measurement occasions 308 according to some aspects of the present disclosure. In some aspects, a first UE (e.g., the UE 115 or UE 800) may receive a cross link interference (CLI) measurement resource configuration from a network unit (e.g., the network unit 105 or 900). In this regard, the first UE may receive the CLI measurement resource configuration from the network unit via a radio resource control (RRC) communication 402. In some aspects, the CLI measurement resource configuration may indicate a plurality of CLI measurement occasions 308 (e.g., CLI measurement occasions 308(0) to 308(n)). The first UE may experience (e.g., be a victim of) CLI from one or more other UEs nearby the first UE. The first UE may measure the CLI in the CLI measurement occasions 308 in order to report the CLI to the network unit and minimize interference effects from the other UEs.

In some aspects, as an alternative to the TDRA table 304, the CLI measurement resource configuration may be explicitly indicated to the first UE. For example, the first UE may receive the CLI measurement resource configuration explicitly indicating the resources. In this regard, the first UE may receive an RRC communication 402 or other suitable communication explicitly indicating the CLI measurement occasion resources.

The CLI measurement resource configuration may indicate a starting symbol associated with each CLI measurement occasion, a number of symbols associated with each CLI measurement occasion, (e.g., start and length indicator value (SLIV)) and/or a slot offset (e.g., K1) associated with each CLI measurement occasion. In some aspects, the CLI measurement resource configuration may indicate resources associated with non-consecutive physical uplink shared channel (PUSCH) communications transmitted by a second UE. The first UE may experience interference caused by communications transmitted by the second UE. The first UE may measure CLI caused by the communications transmitted by the second UE and transmit the measured CLI to a network unit via one or more measurement reports.

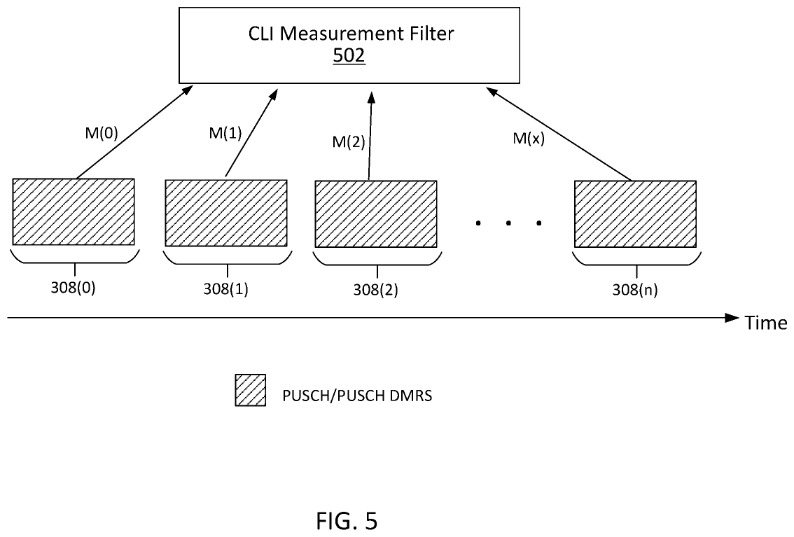

FIG. 5 illustrates a configuration for filtering multiple CLI measurements according to some aspects of the present disclosure. In some aspects, the first UE may measure CLI associated with the second UE. In this regard, the first UE may measure the CLI caused by communications transmitted by the second UE in the plurality of CLI measurement occasions 308. In some aspects, the CLI measurements may include reference signal received power (RSRP) measurements of sounding reference signals (SRSs) transmitted by the second UE. In some aspects, the CLI measurements may include received signal strength indicator (RSSI) measurements associated with PUCCH communications, PUSCH communications, PUSCH DMRSs, and/or SRSs transmitted by the second UE. In some aspects, the CLI measurements may include signal to interference plus noise (SINR) measurements associated with PUCCH communications, PUSCH communications, PUSCH DMRSs, and/or SRSs transmitted by the second UE.

In some aspects, the first UE may transmit one or more CLI measurement reports associated with the measured CLI to the network unit. In this regard, the first UE may transmit the CLI measurement report(s) to the network unit via UCI, a MAC-CE communication, an RRC communication, a PUCCH communication, a PUSCH communication, and/or other suitable communication.

In some aspects, the first UE may receive a measurement reporting indicator from the network unit indicating whether the first UE should transmit a single measurement report comprising all of the CLI measurements and/or multiple measurement reports in which each measurement report of the multiple measurement reports include a CLI measurement for each of the CLI measurement occasions 308. In this regard, the first UE may receive the measurement reporting indicator from the network unit via DCI, a MAC-CE communication, an RRC communication, a PDCCH communication, a PDSCH communication, and/or other suitable communication. The first UE may transmit the single measurement report and/or the multiple measurement reports based on the measurement reporting indicator. For example, the first UE may transmit a single measurement report to the network unit including each CLI measurement corresponding to CLI measurement occasions 308(0) to 308(n). Additionally or alternatively, the first UE may transmit multiple measurement reports to the network unit in which each measurement report includes one or more CLI measurements corresponding to the CLI measurement occasions 308(0) to 308(n). The first UE may transmit the measurement report(s) to the network unit via UCI, a MAC-CE communication, an RRC communication, a PUCCH communication, a PUSCH communication, and/or other suitable communication.

In some aspects, the first UE may receive a filter coefficient from the network unit. The filter coefficient may be associated with the CLI measurement report(s). The first UE may apply the filter coefficient to the CLI measurements M(0) to M(x) using CLI measurement filter 502. In this regard, the filter coefficient may include the coefficient α. The first UE may filter the CLI measurements M(0) to M(x) using CLI measurement filter 502 according to the filter equation: Fₙ=(1−α)Fₙ₋₁+αMₙ, where α is the filter coefficient, M is the CLI measurement, and n is an index corresponding to each of the CLI measurement occasions M(0) to M(x). In this case, the first UE may transmit a single measurement report to the network unit comprising the filtered CLI measurements.

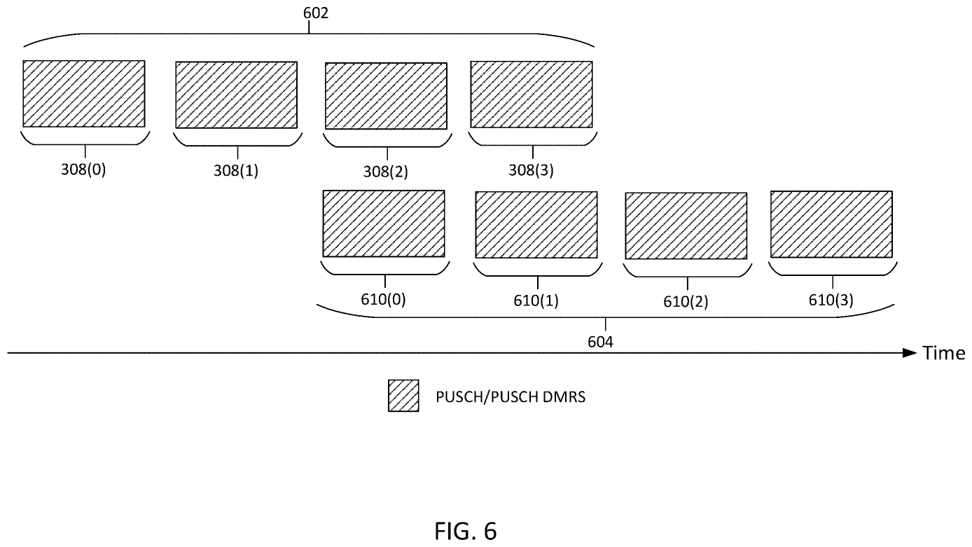

FIG. 6 illustrates overlapping CLI measurement occasions according to some aspects of the present disclosure. In some aspects, one or more of the CLI measurement occasions 308 associated with the second UE may overlap with one or more of the CLI measurement occasions 610 associated with a third UE. For example, CLI measurement occasions 308(2) and 308(3) associated with the second UE may include one or more slots and/or symbols that overlap in time and/or frequency with CLI measurement occasions 610(0) and 61(1) associated with the third UE. In this case, the first UE may refrain from performing the CLI measurements. Additionally or alternatively, the first UE may transmit an indicator to the network unit indicating that the CLI measurements are to be discarded.

In some aspects, when CLI measurement occasions 308(2) and 308(3) associated with the second UE overlap with CLI measurement occasions 610(0) and 610(1) associated with the third UE, the first UE may measure CLI in the non-overlapping CLI measurement occasions 308(0) and 308(1) associated with the second UE and/or in the non-overlapping CLI measurement occasions 610(2) and 610(3) associated with the third UE. The first UE may transmit one or more measurement reports to the network unit comprising CLI measurements associated with non-overlapping CLI measurement occasions 308(0) and 308(1) associated with the second UE and/or non-overlapping CLI measurement occasions 610(2) and 610(3) associated with the third UE.

Additionally or alternatively, when CLI measurement occasions 308(2) and 308(3) associated with the second UE overlap with CLI measurement occasions 610(0) and 610(1) associated with the third UE, the first UE may measure CLI in the non-overlapping CLI measurement occasions 308(0) and 308(1) associated with the second UE and measure CLI in all of the CLI measurement occasions 610(0), 610(1), 610(2) and 610(3) associated with the third UE. In some aspects, the first UE may apply the CLI measurement filter 502 to the non-overlapping CLI measurement occasions 308(0) and 308(1) associated with the second UE and all of the CLI measurement occasions 610(0), 610(1), 610(2) and 610(3) associated with the third UE. In this regard, the CLI measurement filter 502 may use filter coefficient α. In some aspects, filter coefficient αmay be associated with the CLI measurement occasions or indicated to correspond with one row of the TDRA (e.g., indicated as corresponding to an index to a row in the TDRA). In some aspects, each plurality of CLI measurement occasions may be associated with the same value of filter coefficient α or a different value of filter coefficient α. In some aspects, a first set of CLI measurement occasions (e.g., CLI measurement occasions 308) may be associated with a first value of filter coefficient α and a second set of CLI measurement occasions (e.g., CLI measurement occasions 610) may be associated with a second value of filter coefficient α, where the first value is different from the second value. The first UE may filter the CLI measurements according to the filter equation: Fₙ=(1−α)Fₙ₋₁+αMₙ, where α is the filter coefficient, M is the CLI measurement, and n is an index corresponding to each of the non-overlapping CLI measurement occasions 308(0) and 308(1) associated with the second UE and all of the CLI measurement occasions 610(0), 610(1), 610(2) and 610(3) associated with the third UE. In this case, the first UE may transmit a single measurement report to the network unit comprising the filtered CLI measurements. Additionally or alternatively, the first UE may use the filter equation to filter a subset of the CLI measurements corresponding to a subset of the CLI measurement occasions. For example, the first UE may use the filter equation to filter a span of the CLI measurements (e.g., a range of the CLI measurements) corresponding to a span of the CLI measurement occasions. For example, the first UE may use the filter equation to filter CLI measurements corresponding to CLI measurement occasions 308(0) and 308(1) associated with the second UE and 610(0), 610(1) associated with the third UE. As another non-limiting example, the first UE may use the filter equation to filter CLI measurements corresponding to CLI measurement occasions 610(0), 610(1), and 610(3) associated with the third UE.

In some aspects, the first UE may receive a first CLI measurement resource configuration 602 associated with the second UE. The first CLI measurement resource configuration 604 may indicate a first plurality of CLI measurement occasions 308(0), 308(1), 308(2) and 308(3). In some aspects, the first UE may receive a second CLI measurement resource configuration 604 associated with the second UE. The second CLI measurement resource configuration 604 may indicate a second plurality of CLI measurement occasions 610(0), 610(1), 610(2) and 610(3). Although the example of FIG. 6 indicates four CLI measurement occasions in the first CLI measurement resource configuration 602 and four CLI measurement occasions in the second CLI measurement resource configuration 604, the present disclosure is not so limited and the first and second measurement resource configurations may include any number of CLI measurement occasions.

In some aspects, the first plurality of CLI measurement occasions may partially overlap the second plurality of CLI measurement occasions. In this case, the CLI measurement occasions of the second plurality of CLI measurement occasions 610(0), 610(1), 610(2) and 610(3) are scheduled later than the first plurality of CLI measurement occasions 308(0), 308(1), 308(2) and 308(3). For example, the first UE may receive the first (e.g., initial) configuration 602 for CLI measurement occasions associated with the second UE and then subsequently receive a second CLI measurement resource configuration 604 that overrides the initial configuration 602. The CLI measurement occasions of the second configuration may be scheduled later than the first configuration and some of the CLI measurement occasions may overlap (e.g., earlier occasions of the second configuration). For example, CLI measurement occasions 308(2) and 308(3) may overlap with CLI measurement occasions 610(0) and 610(1). In this case, the first UE may measure CLI associated with the non-overlapping CLI measurement occasions 308(0) and 308(1) of the first configuration and/or measure CLI in all of the CLI measurement occasions 610(0), 610(1), 610(2), and 610(3) of the second (e.g., later) configuration. In some aspects, the first UE may transmit a single measurement report comprising the CLI measurements in the non-overlapping CLI measurement occasions 308(0) and 308(1) of the first configuration and the CLI measurements in all of the CLI measurement occasions 610(0), 610(1), 610(2) and 610(3) of the second (e.g., later) configuration. Additionally or alternatively, the first UE may transmit multiple measurement reports. For example, the first UE may transmit a first CLI measurement report comprising the CLI measurements in the non-overlapping CLI measurement occasions 308(0) and 308(1) of the first configuration and a second CLI measurement report comprising the CLI measurements in all of the CLI measurement occasions 610(0), 610(1), 610(2) and 610(3) of the second (e.g., later) configuration.

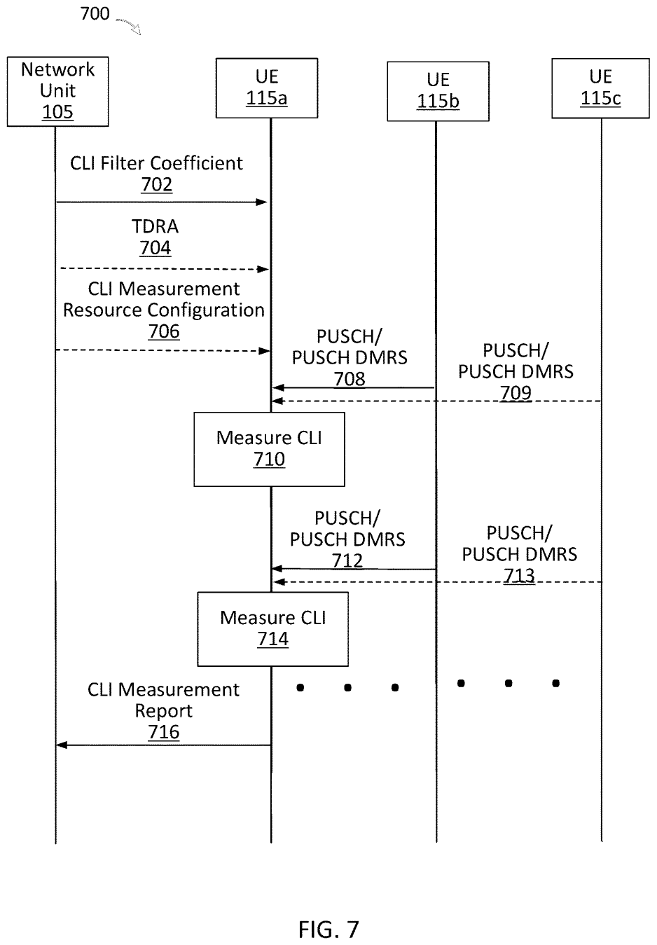

FIG. 7 is a signaling diagram of a wireless communication method 700 according to some aspects of the present disclosure. Actions of the communication method 700 can be executed by a computing device (e.g., a processor, processing circuit, and/or other suitable component) of a communication device or other suitable means for performing the actions. For example, a wireless communication device, such as the UE 115 or UE 800, may utilize one or more components, such as the processor 802, the memory 804, the CLI measurement module 808, the transceiver 810, the modem 812, and the one or more antennas 816, to execute aspects of method 700. A wireless communication device, such as the network unit 105 or 900, may utilize one or more components, such as the processor 902, the memory 904, the CLI measurement module 908, the transceiver 910, the modem 912, and the one or more antennas 916, to execute aspects of method 700.

At action 702, the network unit 105 may transmit a CLI filter coefficient to the UE 115a. In this regard, the network unit 105 may transmit the CLI filter coefficient to the UE 115a via a radio resource control (RRC) communication, downlink control information (DCI), a MAC-CE communication, or other suitable communication. In some aspects, the UE 115a may apply the filter coefficient to the non-overlapping CLI measurement occasions associated with the UE 115b and/or UE 115c. In this regard, the filter coefficient may include α. The first UE may filter the CLI measurements according to the filter equation: Fₙ=(1−α)Fₙ₋₁+αMₙ, where α is the filter coefficient, M is the CLI measurement, and n is an index corresponding to each of the CLI measurement occasions associated with the UE 115b and/or UE 115c.

At action 704, the network unit 105 may transmit a time domain resource allocation (TDRA) table to the UE 115a. In this regard, the network unit 105 may transmit the TDRA table indicating resources associated with physical uplink shared channel (PUSCH) communications scheduled for the UE 115b and/or UE 115c. In this case, the network unit 105 may transmit the CLI measurement resource configuration via an index to an entry in the TDRA table. In this regard, network unit 105 may transmit the index to the TDRA table via DCI. In some aspects, the TDRA table may include multiple rows. The index may point to one of the multiple rows of CLI measurement occasions in the TDRA table. Each row may indicate a plurality of CLI measurement occasions. Each of the CLI measurements occasions may include a starting symbol associated with the CLI measurement occasion, a number of symbols associated with the CLI measurement occasion and/or a slot offset associated with the CLI measurement occasion.

At action 706, the network unit 105 may additionally or alternatively transmit a CLI measurement resource configuration to the UE 115a. The CLI measurement resource configuration may explicitly indicate the CLI measurement resources. In this regard, the network unit 105 may transmit an RRC communication or other suitable communication explicitly indicating the CLI measurement occasion resources. The CLI measurement resource configuration may indicate a starting symbol associated with each CLI measurement occasion, a number of symbols associated with each CLI measurement occasion, and/or a slot offset associated with each CLI measurement occasion. In some aspects, the CLI measurement resource configuration may indicate resources associated with non-consecutive physical uplink shared channel (PUSCH) communications transmitted by the UE 115b and/or UE 115c. The UE 115a may experience interference caused by communications transmitted by the UE 115b and/or UE 115c. The UE 115a may measure CLI caused by the communications transmitted by the UE 115b and/or UE 115c.

At action 708, the UE 115b may transmit a PUCSH/DMRS communication. In this regard, the UE 115b may transmit the PUCSH/DMRS communication in a CLI measurement occasion. The UE 115a may be nearby the UE 115b and therefore the PUCSH/DMRS communication transmitted by the UE 115b may interfere with the UE 115a.

At action 709, the UE 115c may transmit a PUCSH/DMRS communication. In this regard, the UE 115c may transmit the PUCSH/DMRS communication in a CLI measurement occasion. The UE 115a may be nearby the UE 115c and therefore the PUCSH/DMRS communication transmitted by the UE 115c may interfere with the UE 115a.

At action 710, the UE 115a may measure CLI associated with the PUCSH/DMRS communication transmitted at action 708 and/or the PUCSH/DMRS communication transmitted at action 709.

In some aspects, the UE 115a may measure the CLI caused by communications transmitted by the UE 115 and/or the UE 115c in the CLI measurement occasions. In some aspects, the CLI measurement(s) may include reference signal received power (RSRP) measurements of sounding reference signals (SRSs) transmitted by the UE 115 and/or the UE 115c. In some aspects, the CLI measurements may include received signal strength indicator (RSSI) measurements associated with PUCCH communications, PUSCH communications, PUSCH DMRSs, and/or SRSs transmitted by the UE 115 and/or the UE 115c. In some aspects, the CLI measurements may include signal to interference plus noise (SINR) measurements associated with PUCCH communications, PUSCH communications, PUSCH DMRSs, and/or SRSs transmitted by the UE 115 and/or the UE 115c.

In some aspects, the UE 115a may measure the CLI in the CLI measurement occasions based on receiving the CLI measurement resource configuration at action 704 and/or 706. In this case, the UE 115a receiving the CLI measurement resource configuration from the network unit 105 may implicitly indicate to the UE 115a to measure the CLI in the configured CLI measurement occasions. Additionally or alternatively, the UE 115a may receive the CLI measurement resource configuration from the network unit 105 and subsequently receive an indicator (e.g., via DCI, a MAC-CE communication, an RRC communication, a PDCCH communication, a PDSCH communication, and/or other suitable communication) to trigger the CLI measurements.

At action 712, the UE 115b may transmit another PUCSH/DMRS communication. In this regard, the UE 115b may transmit the PUCSH/DMRS communication in a CLI measurement occasion after the CLI measurement occasion associated with action 708. In some aspects, the UE 115b may transmit additional PUCSH/DMRS communication(s) after the PUCSH/DMRS communication transmitted at action 712. The UE 115a may be nearby the UE 115b and therefore the additional PUCSH/DMRS communication(s) transmitted by the UE 115b may interfere with the UE 115a.

At action 713, the UE 115c may transmit another PUCSH/DMRS communication. In this regard, the UE 115c may transmit the PUCSH/DMRS communication in a CLI measurement occasion after the CLI measurement occasion associated with action 709. In some aspects, the UE 115c may transmit additional PUCSH/DMRS communication(s) after the PUCSH/DMRS communication transmitted at action 713. The UE 115a may be nearby the UE 115c and therefore the additional PUCSH/DMRS communication(s) transmitted by the UE 115c may interfere with the UE 115a.

At action 714, the UE 115a may measure CLI associated with the PUCSH/DMRS communication transmitted at action 712 and/or the PUCSH/DMRS communication transmitted at action 713. In some aspects, the UE 115a may measure CLI associated with additional PUCSH/DMRS communication(s) transmitted after the PUCSH/DMRS communications transmitted at actions 712 and/or 713.

In some aspects, the UE 115a may measure the CLI caused by communications transmitted by the UE 115b and/or the UE 115c in the CLI measurement occasions. In some aspects, the CLI measurements may include reference signal received power (RSRP) measurements of sounding reference signals (SRSs) transmitted by the UE 115b and/or the UE 115c. In some aspects, the CLI measurements may include received signal strength indicator (RSSI) measurements associated with PUCCH communications, PUSCH communications, PUSCH DMRSs, and/or SRSs transmitted by the UE 115b and/or the UE 115c. In some aspects, the CLI measurements may include signal to interference plus noise (SINR) measurements associated with PUCCH communications, PUSCH communications, PUSCH DMRSs, and/or SRSs transmitted by the UE 115b and/or the UE 115c.

At action 716, the UE 115a may transmit one or more CLI measurement reports associated with the measured CLI to the network unit 105. In this regard, the UE 115a may transmit the CLI measurement report(s) to the network unit 105 via UCI, a MAC-CE communication, an RRC communication, a PUCCH communication, a PUSCH communication, and/or other suitable communication.

In some aspects, the UE 115a may receive a measurement reporting indicator from the network unit 105 indicating whether the UE 115a should transmit a single measurement report comprising all of the CLI measurements and/or multiple measurement reports in which each measurement report of the multiple measurement reports include a CLI measurement for each of the CLI measurement occasions. In this regard, the UE 115a may receive the measurement reporting indicator from the network unit 105 via DCI, a MAC-CE communication, an RRC communication, a PDCCH communication, a PDSCH communication, and/or other suitable communication. The UE 115a may transmit the single measurement report and/or the multiple measurement reports based on the measurement reporting indicator.

In some aspects, the UE 115a may filter the CLI measurements using the filter coefficient received from the network unit 105 at action 702. The UE 115a may apply the filter coefficient to the CLI measurements taken at actions 710 and 714. In this regard, the filter coefficient may include the coefficient α. The UE 115a may filter the CLI measurements according to the filter equation: Fₙ=(1−α)Fₙ₋₁+αMₙ, where α is the filter coefficient, M is the CLI measurement, and n is an index corresponding to each of the CLI measurement occasions. In some aspects, the UE 115a may apply the filter to the CLI measurements and transmit a single measurement report to the network unit 105 comprising the filtered CLI measurements.

In some aspects, one or more of the CLI measurement occasions associated with the UE 115b may overlap with one or more of the CLI measurement occasions associated with the UE 115c. For example, CLI measurement occasions associated with the UE 115b may include one or more slots and/or symbols that overlap in time and/or frequency with CLI measurement occasions associated with the UE 115c. In this case, the UE 115a may refrain from performing the CLI measurements at actions 710 and/or 714. Additionally or alternatively, the UE 115a may transmit an indicator to the network unit 105 indicating that the measurements are to be discarded.

In some aspects, when CLI measurement occasions associated with the UE 115b overlap with CLI measurement occasions associated with the UE 115c, the UE 115a may measure CLI in the non-overlapping CLI measurement occasions associated with the UE 115b and/or in the non-overlapping CLI measurement occasions associated with the UE 115c. The UE 115a may transmit one or more measurement reports to the network unit 105 comprising CLI measurements associated with non-overlapping CLI measurement occasions associated with the UE 115b and/or non-overlapping CLI measurement occasions associated with the UE 115c.

Additionally or alternatively, when CLI measurement occasions associated with the UE 115b overlap with CLI measurement occasions associated with the UE 115c, the UE 115a may measure CLI in the non-overlapping CLI measurement occasions associated with the UE 115b and measure CLI in all of the CLI measurement occasions associated with the UE 115c. In some aspects, the UE 115a may apply the filter coefficient to the non-overlapping CLI measurement occasions associated with the UE 115b and all of the CLI measurement occasions associated with the UE 115c. In this regard, the filter coefficient may include α. The UE 115a may filter the CLI measurements according to the filter equation: Fₙ=(1−α)Fₙ₋₁+αMₙ, where a is the filter coefficient, M is the CLI measurement, and n is an index corresponding to each of the non-overlapping CLI measurement occasions associated with the UE 115b and all of the CLI measurement occasions associated with the UE 115c. In this case, the UE 115a may transmit a single measurement report to the network unit 105 comprising the filtered CLI measurements.

In some aspects, the UE 115a may receive a second CLI measurement resource configuration associated with the UE 115b. The second CLI measurement resource configuration may indicate a second plurality of CLI measurement occasions partially overlapping the plurality of CLI measurement occasions configured at actions 704 and/or 706. In this case, the CLI measurement occasions of the second plurality of CLI measurement occasions are scheduled later than the plurality of CLI measurement occasions configured at actions 704 and/or 706. For example, the UE 115a may receive the initial configuration for CLI measurement occasions associated with the UE 115b configured at actions 704 and/or 706 and then receive a second configuration that overrides the initial configuration. The CLI measurement occasions of the second configuration may be scheduled later than the initial configuration and some of the CLI measurement occasions may overlap (e.g., earlier occasions of the second configuration). In this case, the UE 115a may measure CLI associated with the non-overlapping portion of the initial configuration and/or measure CLI in all of the CLI measurement occasions of the second (e.g., later) configuration. In some aspects, the UE 115a may transmit a single measurement report to the network unit 105 comprising the CLI measurements in the non-overlapping portion of the initial configuration and the CLI measurements in all of the CLI measurement occasions of the second (e.g., later) configuration. Additionally or alternatively, the UE 115a may transmit multiple measurement reports to the network unit 105. For example, the UE 115a may transmit a first CLI measurement report comprising the CLI measurements in the non-overlapping portion of the initial configuration and a second CLI measurement report comprising the CLI measurements in all of the CLI measurement occasions of the second (e.g., later) configuration.

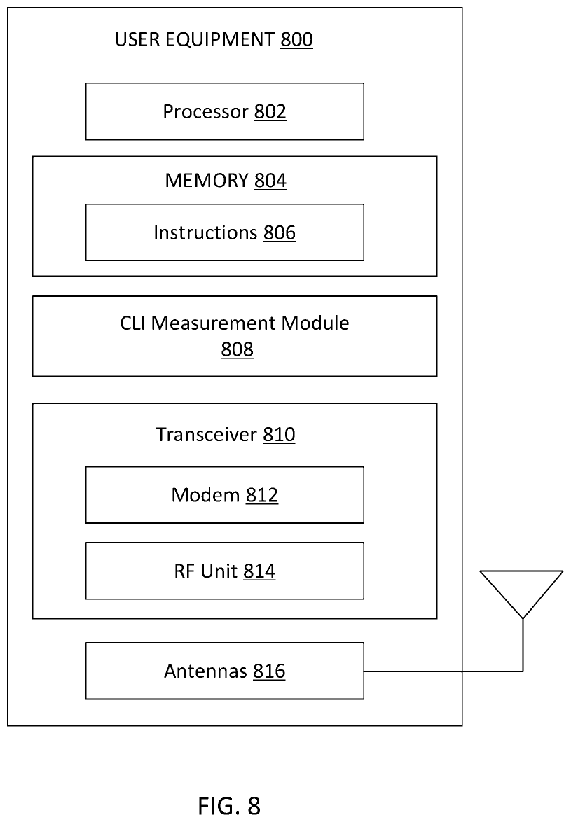

FIG. 8 is a block diagram of an exemplary UE 800 according to some aspects of the present disclosure. The UE 800 may be the UE 115 in the network 100 or 200 as discussed above. As shown, the UE 800 may include a processor 802, a memory 804, a CLI measurement module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 3-7. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The CLI measurement module 808 may be implemented via hardware, software, or combinations thereof. For example, the CLI measurement module 808 may be implemented as a processor, circuit, and/or instructions 806 stored in the memory 804 and executed by the processor 802. In some aspects, the CLI measurement module 808 may implement the aspects of FIGS. 3-7. For example, the CLI measurement module 808 of a first UE (e.g., the UE 115 or 800) may receive, from a network unit (e.g., network unit 105 or 900), a cross link interference (CLI) measurement resource configuration. The CLI measurement resource configuration may indicate a plurality of CLI measurement occasions. The CLI measurement module 808 may measure CLI associated with a second UE (e.g., the UE 115 or 800) in the plurality of CLI measurement occasions. The CLI measurement module 808 may transmit, to the network unit, one or more CLI measurement reports associated with the measured CLI.

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

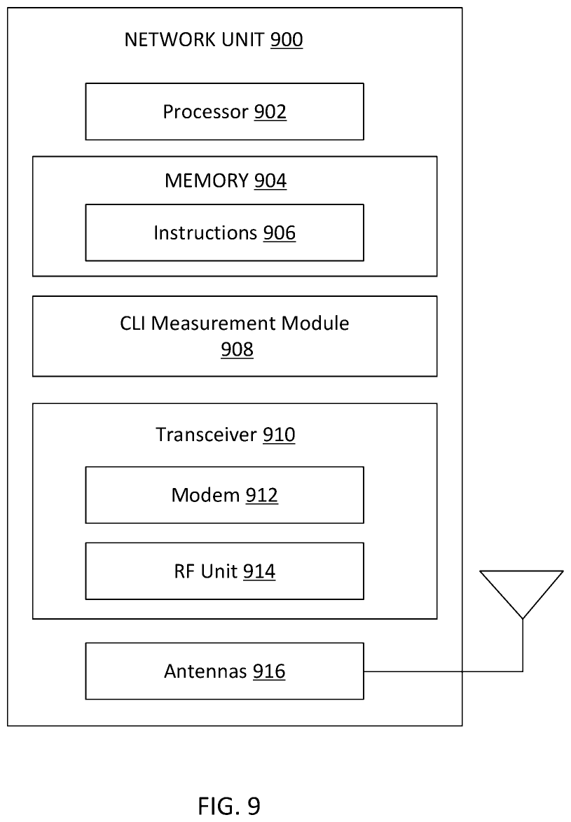

FIG. 9 is a block diagram of an exemplary network unit 900 according to some aspects of the present disclosure. The network unit 900 may be the BS 105, the CU 210, the DU 230, or the RU 240, as discussed above. As shown, the network unit 900 may include a processor 902, a memory 904, a CLI measurement module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 3-7. Instructions 906 may also be referred to as code, which may be interpreted broadly to include any type of computer-readable statement(s).

The CLI measurement module 908 may be implemented via hardware, software, or combinations thereof. For example, the CLI measurement module 908 may be implemented as a processor, circuit, and/or instructions 906 stored in the memory 904 and executed by the processor 902.

In some aspects, the CLI measurement module 908 may implement the aspects of FIGS. 3-7. For example, the CLI measurement module 908 may transmit, to a UE (e.g., the UE 115 or 800), a cross link interference (CLI) measurement resource configuration. The CLI measurement resource configuration may indicate a plurality of CLI measurement occasions. The CLI measurement module 908 may receive one or more CLI measurement reports from the UE associated with CLI associated with a second UE.

As shown, the transceiver 910 may include the modem subsystem 912 and the RF unit 914. The transceiver 910 can be configured to communicate bi-directionally with other devices, such as the UEs 115 and/or 600. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 600. The RF unit 914 may be further configured to perform analog beamforming in conjunction with the digital beamforming. Although shown as integrated together in transceiver 910, the modem subsystem 912 and/or the RF unit 914 may be separate devices that are coupled together at the network unit 900 to enable the network unit 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the network unit 900 can include multiple transceivers 910 implementing different RATs (e.g., NR and LTE). In some instances, the network unit 900 can include a single transceiver 910 implementing multiple RATs (e.g., NR and LTE). In some instances, the transceiver 910 can include various components, where different combinations of components can implement RATs.

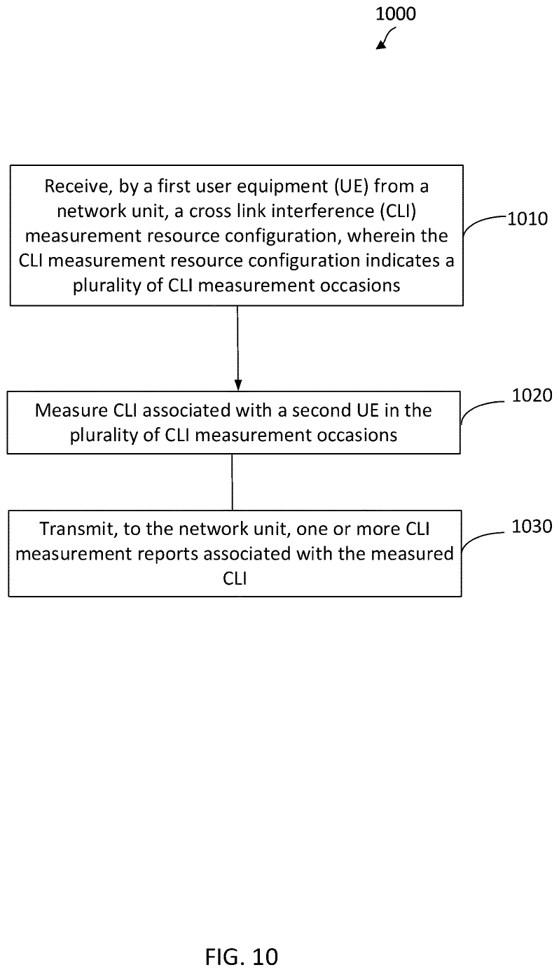

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115 or UE 800 may utilize one or more components to execute aspects of method 1000. The method 1000 may employ similar mechanisms as in the networks 100 and 200 and the aspects and actions described with respect to FIGS. 3-7. For example, a wireless communication device, such as the UE 115 or UE 800, may utilize one or more components, such as such as the processor 802, the memory 804, the CLI measurement module 808, the transceiver 810, the modem 812, and the one or more antennas 816, to execute aspects of the method 1000. As illustrated, the method 1000 includes a number of enumerated aspects, but the method 1000 may include additional aspects before, after, and in between the enumerated aspects. In some aspects, one or more of the enumerated aspects may be omitted or performed in a different order.

At action 1010, the method 1000 includes a first UE (e.g., the UE 115 or UE 800) receiving a cross link interference (CLI) measurement resource configuration from a network unit (e.g., the network unit 105 or 900). In this regard, the first UE may receive the CLI measurement resource configuration from the network unit via a radio resource control (RRC) communication, downlink control information (DCI), a MAC-CE communication, or other suitable communication. In some aspects, the CLI measurement resource configuration may indicate a plurality of CLI measurement occasions. The first UE may experience (e.g., be a victim of) CLI from one or more other UEs nearby the first UE. The first UE may measure the CLI in the CLI measurement occasions in order to report the CLI to the network unit and minimize interference effects from the other UEs.

In some aspects, the first UE may receive a time domain resource allocation (TDRA) table indicating resources associated with physical uplink shared channel (PUSCH) communications scheduled for the second UE. In this case, the first UE may receive the CLI measurement resource configuration via an index to an entry in the TDRA table. In this regard, the first UE may receive the index to the TDRA table via DCI. In some aspects, the TDRA table may include multiple rows. The index may point to one of the multiple rows of CLI measurement occasions. Each row may indicate a plurality of CLI measurement occasions. Each of the CLI measurements occasions may include a starting symbol associated with the CLI measurement occasion, a number of symbols associated with the CLI measurement occasion and/or a slot offset associated with the CLI measurement occasion.

Additionally or alternatively, the CLI measurement resource configuration may be explicitly indicated to the first UE. For example, the first UE may receive the CLI measurement resource configuration explicitly indicating the resources. In this regard, the first UE may receive an RRC communication or other suitable communication explicitly indicating the CLI measurement occasion resources. The CLI measurement resource configuration may indicate a starting symbol associated with each CLI measurement occasion, a number of symbols associated with each CLI measurement occasion, and/or a slot offset associated with each CLI measurement occasion. In some aspects, the CLI measurement resource configuration may indicate resources associated with non-consecutive physical uplink shared channel (PUSCH) communications transmitted by a second UE. The first UE may experience interference caused by communications transmitted by the second UE. The first UE may measure CLI caused by the communications transmitted by the second UE as described with respect to action 1020.

At action 1020, the method 1000 includes the first UE measuring CLI associated with the second UE. In this regard, the first UE may measure the CLI caused by communications transmitted by the second UE in the plurality of CLI measurement occasions. In some aspects, the CLI measurements may include reference signal received power (RSRP) measurements of sounding reference signals (SRSs) transmitted by the second UE. In some aspects, the CLI measurements may include received signal strength indicator (RSSI) measurements associated with PUCCH communications, PUSCH communications, PUSCH DMRSs, and/or SRSs transmitted by the second UE. In some aspects, the CLI measurements may include signal to interference plus noise (SINR) measurements associated with PUCCH communications, PUSCH communications, PUSCH DMRSs, and/or SRSs transmitted by the second UE.

In some aspects, the first UE may measure the CLI in the plurality of CLI measurement occasions based on receiving the CLI measurement resource configuration at action 1010. In this case, the first UE receiving the CLI measurement resource configuration from the network unit at action 1010 may implicitly indicate to the first UE to measure the CLI in the configured CLI measurement occasions. Additionally or alternatively, the first UE may receive the CLI measurement resource configuration from the network unit and subsequently receive an indicator (e.g., via DCI, a MAC-CE communication, an RRC communication, a PDCCH communication, a PDSCH communication, and/or other suitable communication) to trigger the CLI measurements.

At action 1030, the method 1000 includes the first UE transmitting one or more CLI measurement reports associated with the measured CLI to the network unit. In this regard, the first UE may transmit the CLI measurement report(s) to the network unit via UCI, a MAC-CE communication, an RRC communication, a PUCCH communication, a PUSCH communication, and/or other suitable communication.

In some aspects, the first UE may receive a measurement reporting indicator from the network unit indicating whether the first UE should transmit a single measurement report comprising all of the CLI measurements and/or multiple measurement reports in which each measurement report of the multiple measurement reports include a CLI measurement for each of the CLI measurement occasions. In this regard, the first UE may receive the measurement reporting indicator from the network unit via DCI, a MAC-CE communication, an RRC communication, a PDCCH communication, a PDSCH communication, and/or other suitable communication. The first UE may transmit the single measurement report and/or the multiple measurement reports based on the measurement reporting indicator. In this regard, the first UE may transmit the measurement report(s) to the network unit via UCI, a MAC-CE communication, an RRC communication, a PUCCH communication, a PUSCH communication, and/or other suitable communication.

In some aspects, the first UE may receive a filter coefficient from the network unit. The filter coefficient may be associated with the CLI measurement report(s). The first UE may apply the filter coefficient to the CLI measurements. In this regard, the filter coefficient may include the coefficient α. The first UE may filter the CLI measurements according to the filter equation: Fₙ=(1−α)Fₙ₋₁+αMₙ, where α is the filter coefficient, M is the CLI measurement, and n is an index corresponding to each of the CLI measurement occasions. In this case, the first UE may transmit a single measurement report to the network unit comprising the filtered CLI measurements.

In some aspects, one or more of the CLI measurement occasions associated with the second UE may overlap with one or more of the CLI measurement occasions associated with a third UE. For example, CLI measurement occasions associated with the second UE may include one or more slots and/or symbols that overlap in time and/or frequency with CLI measurement occasions associated with the third UE. In this case, the first UE may refrain from performing the CLI measurements. Additionally or alternatively, the first UE may transmit an indicator to the network unit indicating that the measurements are to be discarded.

In some aspects, when CLI measurement occasions associated with the second UE overlap with CLI measurement occasions associated with the third UE, the first UE may measure CLI in the non-overlapping CLI measurement occasions associated with the second UE and/or in the non-overlapping CLI measurement occasions associated with the third UE. The first UE may transmit one or more measurement reports to the network unit comprising CLI measurements associated with non-overlapping CLI measurement occasions associated with the second UE and/or non-overlapping CLI measurement occasions associated with the third UE.

Additionally or alternatively, when CLI measurement occasions associated with the second UE overlap with CLI measurement occasions associated with the third UE, the first UE may measure CLI in the non-overlapping CLI measurement occasions associated with the second UE and measure CLI in all of the CLI measurement occasions associated with the third UE. In some aspects, the first UE may apply the filter coefficient to the non-overlapping CLI measurement occasions associated with the second UE and all of the CLI measurement occasions associated with the third UE. In this regard, the filter coefficient may include α. The first UE may filter the CLI measurements according to the filter equation: Fₙ=(1−α)Fₙ₋₁+αMₙ, where α is the filter coefficient, M is the CLI measurement, and n is an index corresponding to each of the non-overlapping CLI measurement occasions associated with the second UE and all of the CLI measurement occasions associated with the third UE. In this case, the first UE may transmit a single measurement report to the network unit comprising the filtered CLI measurements.

In some aspects, the first UE may receive a second CLI measurement resource configuration associated with the second UE. The second CLI measurement resource configuration may indicate a second plurality of CLI measurement occasions partially overlapping the plurality of CLI measurement occasions. In this case, the CLI measurement occasions of the second plurality of CLI measurement occasions are scheduled later than the plurality of CLI measurement occasions. For example, the first UE may receive the initial configuration for CLI measurement occasions associated with the second UE and then receive a second configuration that overrides the initial configuration. The CLI measurement occasions of the second configuration may be scheduled later than the initial configuration and some of the CLI measurement occasions may overlap (e.g., earlier occasions of the second configuration). In this case, the first UE may measure CLI associated with the non-overlapping portion of the initial configuration and/or measure CLI in all of the CLI measurement occasions of the second (e.g., later) configuration. In some aspects, the first UE may transmit a single measurement report comprising the CLI measurements in the non-overlapping portion of the initial configuration and the CLI measurements in all of the CLI measurement occasions of the second (e.g., later) configuration. Additionally or alternatively, the first UE may transmit multiple measurement reports. For example, the first UE may transmit a first CLI measurement report comprising the CLI measurements in the non-overlapping portion of the initial configuration and a second CLI measurement report comprising the CLI measurements in all of the CLI measurement occasions of the second (e.g., later) configuration.

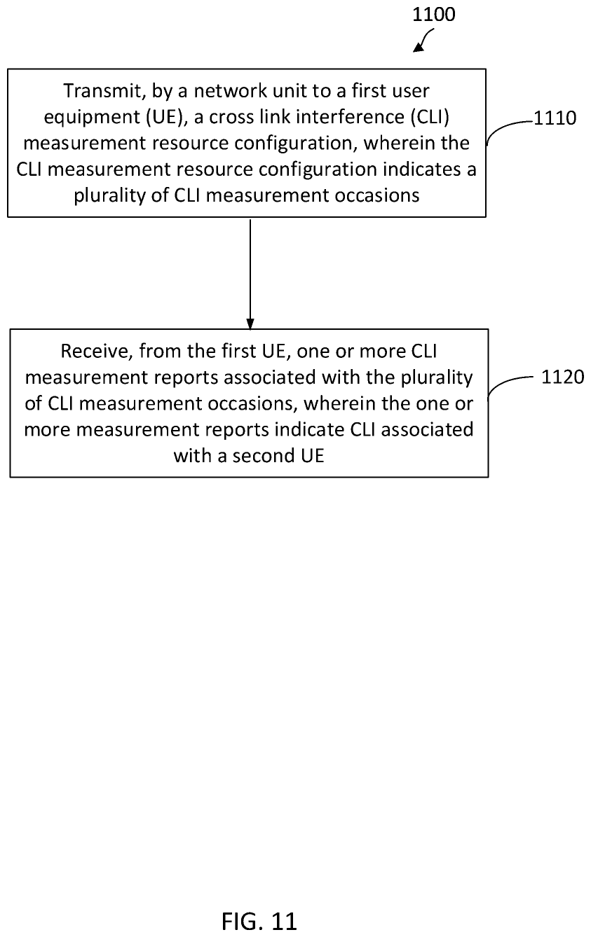

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the network unit 105 or 900 may utilize one or more components to execute aspects of method 1100. The method 1000 may employ similar mechanisms as in the networks 100 and 200 and the aspects and actions described with respect to FIGS. 3-7. For example, a wireless communication device, such as the network unit 105 or 900, may utilize one or more components, such as such as the processor 902, the memory 904, the CLI measurement module 908, the transceiver 910, the modem 912, and the one or more antennas 916, to execute aspects of the method 1100. As illustrated, the method 1100 includes a number of enumerated aspects, but the method 1100 may include additional aspects before, after, and in between the enumerated aspects. In some aspects, one or more of the enumerated aspects may be omitted or performed in a different order.

At action 1110, the method 1100 includes a network unit (e.g., the network unit 105 or 900) transmitting a cross link interference (CLI) measurement resource configuration to a UE (e.g., the UE 115 or 800). In this regard, the network unit may transmit the CLI measurement resource configuration to the UE via a radio resource control (RRC) communication, downlink control information (DCI), a MAC-CE communication, or other suitable communication. In some aspects, the CLI measurement resource configuration may indicate a plurality of CLI measurement occasions. The first UE may experience (e.g., be a victim of) CLI from one or more other UEs nearby the first UE. The first UE may measure the CLI in the CLI measurement occasions in order to report the CLI to the network unit and minimize interference effects from the other UEs.

In some aspects, the network unit may transmit a time domain resource allocation (TDRA) table indicating resources associated with physical uplink shared channel (PUSCH) communications scheduled for the second UE. In this case, the network unit may transmit the CLI measurement resource configuration via an index to an entry in the TDRA table. In this regard, the network unit may transmit the index to the TDRA table via DCI. In some aspects, the TDRA table may include multiple rows. The index may point to one of the multiple rows of CLI measurement occasions. Each row may indicate a plurality of CLI measurement occasions. Each of the CLI measurements occasions may include a starting symbol associated with the CLI measurement occasion, a number of symbols associated with the CLI measurement occasion and/or a slot offset associated with the CLI measurement occasion.

Additionally or alternatively, the CLI measurement resource configuration may be explicitly indicated to the first UE. For example, the network unit may transmit the CLI measurement resource configuration explicitly indicating the resources. In this regard, the network unit may transmit an RRC communication or other suitable communication explicitly indicating the CLI measurement occasion resources. The CLI measurement resource configuration may indicate a starting symbol associated with each CLI measurement occasion, a number of symbols associated with each CLI measurement occasion, and/or a slot offset associated with each CLI measurement occasion. In some aspects, the CLI measurement resource configuration may indicate resources associated with non-consecutive physical uplink shared channel (PUSCH) communications transmitted by a second UE. The first UE may experience interference caused by communications transmitted by the second UE. The first UE may measure CLI caused by the communications transmitted by the second UE as described with respect to action 1120.

The first UE may measure CLI associated with the second UE. In this regard, the first UE may measure the CLI caused by communications transmitted by the second UE in the plurality of CLI measurement occasions. In some aspects, the CLI measurements may include reference signal received power (RSRP) measurements of sounding reference signals (SRSs) transmitted by the second UE. In some aspects, the CLI measurements may include received signal strength indicator (RSSI) measurements associated with PUCCH communications, PUSCH communications, PUSCH DMRSs, and/or SRSs transmitted by the second UE. In some aspects, the CLI measurements may include signal to interference plus noise (SINR) measurements associated with PUCCH communications, PUSCH communications, PUSCH DMRSs, and/or SRSs transmitted by the second UE.

In some aspects, the first UE may measure the CLI in the plurality of CLI measurement occasions based on receiving the CLI measurement resource configuration at action 1110. In this case, the first UE receiving the CLI measurement resource configuration from the network unit at action 1110 may implicitly indicate to the first UE to measure the CLI in the configured CLI measurement occasions. Additionally or alternatively, the first UE may receive the CLI measurement resource configuration from the network unit and subsequently receive an indicator (e.g., via DCI, a MAC-CE communication, an RRC communication, a PDCCH communication, a PDSCH communication, and/or other suitable communication) to trigger the CLI measurements.

At action 1120, the method 1100 includes the network unit receiving one or more CLI measurement reports associated with the measured CLI from the first UE. In this regard, the network unit may receive the CLI measurement report(s) from the first UE via UCI, a MAC-CE communication, an RRC communication, a PUCCH communication, a PUSCH communication, and/or other suitable communication.

In some aspects, the network unit may transmit a measurement reporting indicator to the first UE indicating whether the first UE should transmit a single measurement report comprising all of the CLI measurements and/or multiple measurement reports in which each measurement report of the multiple measurement reports include a CLI measurement for each of the CLI measurement occasions. In this regard, the network unit may transmit the measurement reporting indicator to the first UE via DCI, a MAC-CE communication, an RRC communication, a PDCCH communication, a PDSCH communication, and/or other suitable communication. The network unit may receive the single measurement report and/or the multiple measurement reports based on the measurement reporting indicator. In this regard, the network unit may receive the measurement report(s) from the first UE via UCI, a MAC-CE communication, an RRC communication, a PUCCH communication, a PUSCH communication, and/or other suitable communication.

In some aspects, the first UE may receive a filter coefficient from the network unit. The filter coefficient may be associated with the CLI measurement report(s). The first UE may apply the filter coefficient to the CLI measurements. In this regard, the filter coefficient may include the coefficient α. The first UE may filter the CLI measurements according to the filter equation: Fₙ=(1−α)Fₙ₋₁+αMₙ, where α is the filter coefficient, M is the CLI measurement, and n is an index corresponding to each of the CLI measurement occasions. In this case, the first UE may transmit a single measurement report to the network unit comprising the filtered CLI measurements.

In some aspects, one or more of the CLI measurement occasions associated with the second UE may overlap with one or more of the CLI measurement occasions associated with a third UE. For example, CLI measurement occasions associated with the second UE may include one or more slots and/or symbols that overlap in time and/or frequency with CLI measurement occasions associated with the third UE. In this case, the first UE may refrain from performing the CLI measurements. Additionally or alternatively, the network unit may receive an indicator from the first UE indicating that the measurements are to be discarded.

In some aspects, when CLI measurement occasions associated with the second UE overlap with CLI measurement occasions associated with the third UE, the first UE may measure CLI in the non-overlapping CLI measurement occasions associated with the second UE and/or in the non-overlapping CLI measurement occasions associated with the third UE. The network unit may receive one or more measurement reports from the first UE comprising CLI measurements associated with non-overlapping CLI measurement occasions associated with the second UE and/or non-overlapping CLI measurement occasions associated with the third UE.

Additionally or alternatively, when CLI measurement occasions associated with the second UE overlap with CLI measurement occasions associated with the third UE, the first UE may measure CLI in the non-overlapping CLI measurement occasions associated with the second UE and measure CLI in all of the CLI measurement occasions associated with the third UE. In some aspects, the first UE may apply the filter coefficient to the non-overlapping CLI measurement occasions associated with the second UE and all of the CLI measurement occasions associated with the third UE. In this regard, the filter coefficient may include α. The first UE may filter the CLI measurements according to the filter equation: Fₙ=(1−α)Fₙ₋₁+αMₙ, where α is the filter coefficient, M is the CLI measurement, and n is an index corresponding to each of the non-overlapping CLI measurement occasions associated with the second UE and all of the CLI measurement occasions associated with the third UE. In this case, the network unit may receive a single measurement report from the first UE comprising the filtered CLI measurements.

In some aspects, the network unit may transmit a second CLI measurement resource configuration associated with the second UE. The second CLI measurement resource configuration may indicate a second plurality of CLI measurement occasions partially overlapping the plurality of CLI measurement occasions. In this case, the CLI measurement occasions of the second plurality of CLI measurement occasions are scheduled later than the plurality of CLI measurement occasions. For example, the network unit may transmit the initial configuration for CLI measurement occasions associated with the second UE and then transmit a second configuration that overrides the initial configuration. The CLI measurement occasions of the second configuration may be scheduled later than the initial configuration and some of the CLI measurement occasions may overlap (e.g., earlier occasions of the second configuration). In this case, the first UE may measure CLI associated with the non-overlapping portion of the initial configuration and/or measure CLI in all of the CLI measurement occasions of the second (e.g., later) configuration. In some aspects, the network unit may receive a single measurement report comprising the CLI measurements in the non-overlapping portion of the initial configuration and the CLI measurements in all of the CLI measurement occasions of the second (e.g., later) configuration. Additionally or alternatively, the network unit may receive multiple measurement reports. For example, the network unit may receive a first CLI measurement report comprising the CLI measurements in the non-overlapping portion of the initial configuration and a second CLI measurement report comprising the CLI measurements in all of the CLI measurement occasions of the second (e.g., later) configuration.

Further aspects of the present disclosure include the following:

Aspect 1 includes a method of wireless communication performed by a first user equipment (UE), the method comprising receiving, from a network unit, a cross link interference (CLI) measurement resource configuration, wherein the CLI measurement resource configuration indicates a plurality of CLI measurement occasions; measuring CLI associated with a second UE in the plurality of CLI measurement occasions; and transmitting, to the network unit, one or more CLI measurement reports associated with the measured CLI.

Aspect 2 includes the method of aspect 1, wherein the measuring the CLI is based on the receiving the CLI measurement resource configuration.

Aspect 3 includes the method of any of aspects 1-2, further comprising receiving, from the network unit, a time domain resource allocation (TDRA) table indicating resources associated with physical uplink shared channel (PUSCH) communications scheduled for the second UE, wherein the receiving the CLI measurement resource configuration comprises receiving, in downlink control information (DCI), the CLI measurement resource configuration via an index to an entry in the TDRA table.

Aspect 4 includes the method of any of aspects 1-3, wherein the receiving the CLI measurement resource configuration comprises receiving the CLI measurement resource configuration via a radio resource control (RRC) communication.

Aspect 5 includes the method of any of aspects 1-4, wherein the CLI measurement resource configuration indicates at least one of a starting symbol associated with each CLI measurement occasion of the plurality of CLI measurement occasions; a number of symbols associated with each CLI measurement occasion of the plurality of CLI measurement occasions; or a slot offset associated with each CLI measurement occasion of the plurality of CLI measurement occasions.

Aspect 6 includes the method of any of aspects 1-5, wherein the CLI measurement resource configuration indicates resources associated with non-consecutive physical uplink shared channel (PUSCH) communications transmitted by the second UE.

Aspect 7 includes the method of any of aspects 1-6, wherein the measuring the CLI associated with the second UE in the plurality of CLI measurement occasions comprises at least one of measuring a received signal strength associated with one or more physical uplink shared channel (PUSCH) communications transmitted by the second UE; or measuring a reference signal received power (RSRP) or a signal to interference plus noise ratio (SINR) associated with one or more demodulation reference signals (DMRSs) transmitted by the second UE.

Aspect 8 includes the method of any of aspects 1-7, wherein the transmitting the one or more CLI measurement reports comprises transmitting, to the network unit, a plurality of CLI measurement reports, wherein each CLI measurement report of the plurality of measurement reports is associated with a CLI measurement in each of the plurality of CLI measurement occasions.

Aspect 9 includes the method of any of aspects 1-8, further comprising receiving, from the network unit, an indicator indicating the one or more CLI measurement reports comprises a single CLI measurement report; and wherein the transmitting the one or more CLI measurement reports comprises transmitting, to the network unit, the single measurement report.

Aspect 10 includes the method of any of aspects 1-9, further comprising receiving, from the network unit, a filter coefficient associated with the one or more CLI measurement reports; and applying, to the CLI measurements, the filter coefficient, wherein the transmitting the one or more CLI measurement reports comprises transmitting, to the network unit, a single measurement report associated with the CLI measurements.

Aspect 11 includes the method of any of aspects 1-10, wherein the plurality of CLI measurement occasions comprises first CLI measurement occasions associated with the second UE and second CLI measurement occasions associated with a third UE; one or more of the first CLI measurement occasions overlaps with one or more of the second CLI measurement occasions; and the one or more CLI measurement reports comprises an indicator indicating the CLI measurements are to be discarded.

Aspect 12 includes the method of any of aspects 1-11, wherein the plurality of CLI measurement occasions comprises first CLI measurement occasions associated with the second UE and second CLI measurement occasions associated with a third UE; one or more of the first CLI measurement occasions overlaps with one or more of the second CLI measurement occasions; and the one or more CLI measurement reports comprises one or more CLI measurement reports associated with non-overlapping CLI measurement occasions of the first CLI measurement occasions and the second CLI measurement occasions.

Aspect 13 includes the method of any of aspects 1-12, further comprising receiving, from the network unit, a filter coefficient associated with the one or more CLI measurement reports, wherein the plurality of CLI measurement occasions comprises first CLI measurement occasions associated with the second UE and second CLI measurement occasions associated with a third UE; one or more of the first CLI measurement occasions overlaps with one or more of the second CLI measurement occasions; and applying the filter coefficient to CLI measurements in non-overlapping CLI measurement occasions of the first CLI measurement occasions and the second CLI measurement occasions.

Aspect 14 includes the method of any of aspects 1-13, further comprising: receiving, from the network unit, a second CLI measurement resource configuration, wherein the second CLI measurement resource configuration indicates a second plurality of CLI measurement occasions partially overlapping the plurality of CLI measurement occasions; one or more of CLI measurement occasions of the second plurality of CLI measurement occasions are scheduled later than the plurality of CLI measurement occasions; the measuring the CLI comprises measuring CLI associated with the second plurality of CLI measurement occasions; and the transmitting the one or more CLI measurement reports comprises transmitting one or more CLI measurement reports associated with the second plurality of CLI measurement occasions.

Aspect 15 includes a method of wireless communication performed by a network unit, the method comprising transmitting, to a first user equipment (UE), a cross link interference (CLI) measurement resource configuration, wherein the CLI measurement resource configuration indicates a plurality of CLI measurement occasions; and receiving, from the first UE, one or more CLI measurement reports associated with the plurality of CLI measurement occasions, wherein the one or more measurement reports indicate CLI associated with a second UE.

Aspect 16 includes a non-transitory computer-readable medium storing one or more instructions for wireless communication, the one or more instructions comprising one or more instructions that, when executed by one or more processors of a first UE perform any one of aspects 1-14.

Aspect 17 includes a non-transitory computer-readable medium storing one or more instructions for wireless communication, the one or more instructions comprising one or more instructions that, when executed by one or more processors of a network unit perform any one of aspect 15.

Aspect 18 includes a first UE comprising one or more means to perform any one or more of aspects 1-14.

Aspect 19 includes a network unit comprising one or more means to perform any one or more of aspect 15.

Aspect 20 includes a first UE comprising a memory; a transceiver; and at least one processor coupled to the memory and the transceiver, wherein the first UE is configured to perform any one or more of aspects 1-14.

Aspect 21 includes a network unit comprising a memory; a transceiver; and at least one processor coupled to the memory and the transceiver, wherein the network unit is configured to perform any one or more of aspect 15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first user equipment (UE), the method comprising:
receiving, from a network unit, a cross link interference (CLI) measurement resource configuration, wherein the CLI measurement resource configuration indicates a plurality of CLI measurement occasions;
measuring CLI associated with a second UE in the plurality of CLI measurement occasions; and
transmitting, to the network unit, one or more CLI measurement reports associated with the measured CLI.

2. The method of claim 1, wherein the measuring the CLI is based on the receiving the CLI measurement resource configuration.

3. The method of claim 1, further comprising:
receiving, from the network unit, a time domain resource allocation (TDRA) table indicating resources associated with physical uplink shared channel (PUSCH) communications scheduled for the second UE, wherein the receiving the CLI measurement resource configuration comprises receiving, in downlink control information (DCI), the CLI measurement resource configuration via an index to an entry in the TDRA table.

4. The method of claim 1, wherein the receiving the CLI measurement resource configuration comprises receiving the CLI measurement resource configuration via a radio resource control (RRC) communication.

5. The method of claim 1, wherein the CLI measurement resource configuration indicates at least one of:
a starting symbol associated with each CLI measurement occasion of the plurality of CLI measurement occasions;
a number of symbols associated with each CLI measurement occasion of the plurality of CLI measurement occasions; or
a slot offset associated with each CLI measurement occasion of the plurality of CLI measurement occasions.

6. The method of claim 1, wherein the CLI measurement resource configuration indicates resources associated with non-consecutive physical uplink shared channel (PUSCH) communications transmitted by the second UE.

7. The method of claim 1, wherein the measuring the CLI associated with the second UE in the plurality of CLI measurement occasions comprises at least one of:
measuring a received signal strength associated with one or more physical uplink shared channel (PUSCH) communications transmitted by the second UE; or
measuring a reference signal received power (RSRP) or a signal to interference plus noise ratio (SINR) associated with one or more demodulation reference signals (DMRSs) transmitted by the second UE.

8. The method of claim 1, wherein the transmitting the one or more CLI measurement reports comprises transmitting, to the network unit, a plurality of CLI measurement reports, wherein each CLI measurement report of the plurality of CLI measurement reports is associated with a CLI measurement in each of the plurality of CLI measurement occasions.

9. The method of claim 1, further comprising:
receiving, from the network unit, an indicator indicating the one or more CLI measurement reports comprises a single CLI measurement report; and wherein the transmitting the one or more CLI measurement reports comprises transmitting, to the network unit, the single CLI measurement report.

10. The method of claim 1, further comprising:
receiving, from the network unit, a filter coefficient associated with the one or more CLI measurement reports; and
applying, to the CLI measurements, the filter coefficient, wherein the transmitting the one or more CLI measurement reports comprises transmitting, to the network unit, a single measurement report associated with the CLI measurements.

11. The method of claim 1, wherein:
the plurality of CLI measurement occasions comprises first CLI measurement occasions associated with the second UE and second CLI measurement occasions associated with a third UE;
one or more of the first CLI measurement occasions overlaps with one or more of the second CLI measurement occasions; and
the one or more CLI measurement reports comprises an indicator indicating the CLI measurements are to be discarded.

12. The method of claim 1, wherein:
the plurality of CLI measurement occasions comprises first CLI measurement occasions associated with the second UE and second CLI measurement occasions associated with a third UE;
one or more of the first CLI measurement occasions overlaps with one or more of the second CLI measurement occasions; and
the one or more CLI measurement reports comprises one or more CLI measurement reports associated with non-overlapping CLI measurement occasions of the first CLI measurement occasions and the second CLI measurement occasions.

13. The method of claim 1, further comprising:
receiving, from the network unit, a filter coefficient associated with the one or more CLI measurement reports, wherein:
the plurality of CLI measurement occasions comprises first CLI measurement occasions associated with the second UE and second CLI measurement occasions associated with a third UE;
one or more of the first CLI measurement occasions overlaps with one or more of the second CLI measurement occasions; and
applying the filter coefficient to CLI measurements in non-overlapping CLI measurement occasions of the first CLI measurement occasions and the second CLI measurement occasions.

14. The method of claim 1, further comprising:
receiving, from the network unit, a second CLI measurement resource configuration, wherein:
the second CLI measurement resource configuration indicates a second plurality of CLI measurement occasions partially overlapping the plurality of CLI measurement occasions;
one or more of CLI measurement occasions of the second plurality of CLI measurement occasions are scheduled later than the plurality of CLI measurement occasions;
the measuring the CLI comprises measuring CLI associated with the second plurality of CLI measurement occasions; and
the transmitting the one or more CLI measurement reports comprises transmitting one or more CLI measurement reports associated with the second plurality of CLI measurement occasions.

15. A method of wireless communication performed by a network unit, the method comprising:
transmitting, to a first user equipment (UE), a cross link interference (CLI) measurement resource configuration, wherein the CLI measurement resource configuration indicates a plurality of CLI measurement occasions; and
receiving, from the first UE, one or more CLI measurement reports associated with the plurality of CLI measurement occasions, wherein the one or more CLI measurement reports indicate CLI associated with a second UE.

16. A first user equipment (UE) comprising:
a memory;
a transceiver; and
at least one processor coupled to the memory and the transceiver, wherein the memory, the transceiver and the at least one processor, individually or collectively, are configured to cause the UE to:
receive, from a network unit, a cross link interference (CLI) measurement resource configuration, wherein the CLI measurement resource configuration indicates a plurality of CLI measurement occasions;
measure CLI associated with a second UE in the plurality of CLI measurement occasions; and
transmit, to the network unit, one or more CLI measurement reports associated with the measured CLI.

17. The first UE of claim 16, wherein the first UE is further configured to measure the CLI based on the receiving the CLI measurement resource configuration.

18. The first UE of claim 16, wherein the first UE is further configured to: receive, from the network unit, a time domain resource allocation (TDRA) table indicating resources associated with physical uplink shared channel (PUSCH) communications scheduled for the second UE; and
receive, in downlink control information (DCI), the CLI measurement resource configuration via an index to an entry in the TDRA table.

19. The first UE of claim 16, wherein the first UE is further configured to:
receive the CLI measurement resource configuration via a radio resource control (RRC) communication.

20. The first UE of claim 16, wherein the CLI measurement resource configuration indicates at least one of:
a starting symbol associated with each CLI measurement occasion of the plurality of CLI measurement occasions;
a number of symbols associated with each CLI measurement occasion of the plurality of CLI measurement occasions; or
a slot offset associated with each CLI measurement occasion of the plurality of CLI measurement occasions.

21.-30. (canceled)
